(19) United States
(12) Patent Application Publication
(10) Pub. No.: US 2019/0160799 A1
(43) Pub. Date: May 30, 2019

(54) DEVICE AND METHOD FOR MANUFACTURING VEHICLE SHEET USING MOISTURE-CURING POLYURETHANE HOT MELT

(71) Applicant: S&B CO., LTD., Gyeongju-si (KR)

(72) Inventors: Seoung Jee Lee, Gyeongju-si (KR); Jae Keun Sung, Ulsan (KR); Jong Hee Park, Gyeongju-si (KR); Kwang Youn Cho, Ulsan (KR); Chong Hoon Lee, Ulsan (KR)

(73) Assignee: S&B CO., LTD., Gyeongju-si (KR)

(21) Appl. No.: 16/031,284

(22) Filed: Jul. 10, 2018

(30) Foreign Application Priority Data
Nov. 24, 2017 (KR) 10-2017-0158270

(51) Int. Cl. B32B 37/12; B32B 37/10; B32B 37/06; B32B 37/20

(52) U.S. Cl. CPC B32B 37/1284; B32B 37/1207; B32B 7/12; B32B 37/06; B32B 37/203; B32B 37/10

(57) ABSTRACT

Disclosed are a device and a method for manufacturing a vehicle sheet using a moisture-curing polyurethane hot melt. The device includes a first coating unit coating a supplied material with a first adhesive, a first pressing roller pressing a polyurethane foam which is supplied to the material coated with the first adhesive, a second coating unit coating a backing cloth, which is supplied while being spread using a screw roller, with a second adhesive, and a second pressing roller pressing the backing cloth coated with the second adhesive or a non-woven fabric on the pressed polyurethane foam, thus manufacturing the vehicle sheet.

### BACKGROUND OF THE INVENTION

### 1. Field of the Invention

The present invention relates to a device and a method for manufacturing a vehicle sheet using a moisture-curing polyurethane hot melt. More particularly, the present invention relates to a device and a method for manufacturing a vehicle sheet using a moisture-curing polyurethane hot melt for manufacturing vehicle sheets.

### 2. Description of the Related Art

FIG. 1 is an illustrative view showing a conventional vehicle sheet, and FIG. 2 is an illustrative view showing a conventional device for manufacturing a vehicle sheet.

A conventional moisture-curing polyurethane hot melt adhesive has a merit in that the adhesive is capable of being cured using moisture instead of flame. Accordingly, the adhesive is widely used as an eco-friendly adhesive. The drawback thereof is that since the curing time of the moisture-curing polyurethane hot melt adhesive is long, when the adhesive is applied to interior materials for vehicles, the time required to deliver products is lengthened. Therefore, it is difficult to apply the moisture-curing polyurethane hot melt adhesive to the production environment of vehicle sheets.

For example, since it takes 3 to 5 days to completely cure the adhesive, when urgent delivery is required, during secondary processing work of cutting materials, workability is reduced, and a phenomenon of peeling between materials and polyurethane occurs because complete curing has not yet been achieved.

A manufacturing method (facility) in which single-surface working is performed using the adhesion method of the moisture-curing polyurethane hot melt adhesive is widely used. The single-surface working method includes a method of coating a polyurethane foam (sponge) surface. When the foam surface is coated, the coating amount may depend greatly on the density and the thickness of the foam.

Only single-surface working is feasible, and production efficiency is lowered, when using conventional facilities. In the case in which secondary single-surface working is performed after the first single-surface working, when the conventional polyurethane foam surface is coated, the coating amount depends greatly on the density and the thickness of the foam, and material costs are increased. The complete curing time (delivery time) is 3 to 5 days.

In the moisture-curing polyurethane hot melt working, when the polyurethane foam surface is coated with an adhesive, the coating amount depends on the thickness and the density of polyurethane foam, which is at least 20 to 50 g/m². The thickness and the density of the polyurethane foam depend on the application area of interior materials for vehicles. Accordingly, due to frequent changes in working conditions, production efficiency is lowered and there is a factor of increase in material costs due to variation in the coating amount. Further, when the polyurethane foam surface is coated with the adhesive, if the coating amount is large, the adhesive is adsorbed in a large amount on the polyurethane foam surface by an adhesive pressing roller, and accordingly, it has been confirmed that the thickness of the polyurethane foam is reduced by 1 mm.

### CITATION LIST

### Patent Literature

(Patent Document 1) Korean Patent No. 10-0778015, Device and method for manufacturing floor mat for vehicles

(Patent Document 2) Korean Patent No. 20-0311880, Device for manufacturing anti-slip sheet for vehicles

### SUMMARY OF THE INVENTION

Accordingly, the present invention has been made keeping in mind the above problems occurring in the related art, and an object of the present invention is to provide a device and a method for manufacturing a vehicle sheet using a moisture-curing polyurethane hot melt, in which defects are reduced during the manufacture of the vehicle sheet and the manufacturing time is shortened.

In order to accomplish the above object, the present invention provides a device for manufacturing a vehicle sheet using a moisture-curing polyurethane hot melt. The device includes a first coating unit 10 coating supplied materials with a first adhesive, a first pressing roller 21 pressing a polyurethane foam which is supplied to the materials coated with the first adhesive, a second coating unit 30 coating a backing cloth, which is supplied while being spread using a screw roller, with a second adhesive, and a second pressing roller 41 pressing the backing cloth coated with the second adhesive or a non-woven fabric on the pressed polyurethane foam, thus manufacturing the vehicle sheet.

Further, the first adhesive and the second adhesive are a moisture-curing polyurethane adhesive, the coating amount of the first adhesive is 10 to 30 g/m², the coating amount of the second adhesive is 5 to 20 g/m², the viscosity of the resin is 20000 mPa·s, and the temperature of the adhesive melting roller is 100° C. Backward flow of the adhesive due to the pressure of the pressing roller 41 during coating is prevented only when the backing cloth is coated to a coating thickness of 0.10 mm or less, which is comparable to the thickness of the thinnest yarn, that is, 15 deniers.

Further, the device further includes a cooling unit 50 cooling the vehicle sheet after passing through the second pressing roller 41 to a cooling temperature of 0 to 10° C. and a cooling air pressure of 0.03 to 0.10 mPa using a cooling nozzle.

Further, the device further includes a humidifying unit 60 curing the vehicle sheet after passing through the cooling unit 50 at a relative humidity of 70 to 95%, a humidifying-nozzle air pressure of 0.03 to 0.10 mPa, and an internal temperature of 30 to 40° C. using a humidifying nozzle.

Further, the present invention provides a method of manufacturing a vehicle sheet using a moisture-curing polyurethane hot melt. The method includes coating supplied materials with a first adhesive, first-pressing a polyurethane foam which is supplied to the materials coated with the first adhesive, coating a backing cloth, which is supplied while being spread using a screw roller, with a second adhesive, and second-pressing the backing cloth coated with the second adhesive on the pressed polyurethane foam, thus manufacturing the vehicle sheet.

Further, the first adhesive and the second adhesive are a moisture-curing polyurethane adhesive, the coating amount of the first adhesive is 10 to 30 g/m², the coating amount of the second adhesive is 5 to 20 g/m², the viscosity of the resin is 20000 mPa·s, and the temperature of the adhesive melting roller is 100° C.

Further, the method further includes cooling the manufactured vehicle sheet to a cooling temperature of 0 to 10° C. and a cooling air pressure of 0.03 to 0.10 mPa using a cooling nozzle.

Further, the method further includes curing the vehicle sheet after passing through the cooling step at a relative humidity of 70 to 95%, a humidifying-nozzle air pressure of 0.03 to 0.10 mPa, and an internal temperature of 30 to 40° C. using a humidifying nozzle.

When the device and the method for manufacturing the vehicle sheet using the moisture-curing polyurethane hot melt according to the present invention as described above are used, it is possible to manufacture a vehicle sheet in which materials, a polyurethane foam, and a backing cloth are adhered.

Further, there is a merit in that the vehicle sheet is cooled using a cooling nozzle to thus shorten the manufacturing time of the vehicle sheet.

Further, there is a merit in that the vehicle sheet is humidified and cured using a humidifying nozzle to thus shorten the manufacturing time of the vehicle sheet.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an illustrative view showing a conventional vehicle sheet;

FIG. 2 is an illustrative view showing a conventional device for manufacturing a vehicle sheet;

FIG. 3 is an illustrative view showing a vehicle sheet according to the present invention;

FIG. 4 is an illustrative view showing a device for manufacturing a vehicle sheet according to the present invention;

FIG. 5 is an illustrative view showing a cooling unit 50;

FIG. 6 shows a peeling test report;

FIG. 7 shows a peeling test report;

FIG. 8 is an illustrative view showing an accumulator;

FIG. 9 is an illustrative view showing a humidifying unit 60;

FIG. 10 shows a peeling test report;

FIG. 11 shows a peeling test report;

FIG. 12 is an illustrative view showing the overall constitution of the device for manufacturing the vehicle sheet according to the present invention; and

FIG. 13 is an operation flowchart showing a method of manufacturing a vehicle sheet.

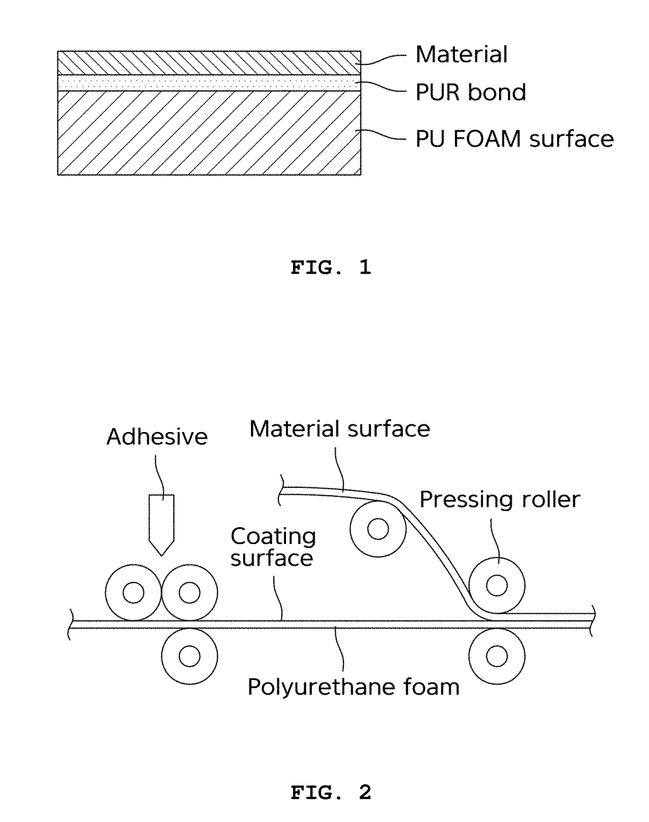

### DESCRIPTION OF THE PREFERRED EMBODIMENTS

Unless defined otherwise, all the terms used in this specification including technical and scientific terms have the same meanings as would be generally understood by those skilled in the related art. The terms defined in generally used dictionaries should be construed as having the same meanings as would be understood in the context of the related art, and unless clearly defined in this specification, should not be construed as having idealistic or overly formal meanings.

Hereinafter, preferred embodiments according to the present invention will be described in detail with reference to the accompanying drawings.

FIG. 3 is an illustrative view showing a vehicle sheet according to the present invention.

In the vehicle sheet, material 11 is coated with a first adhesive 12, a polyurethane foam 13 is adhered to the first adhesive 12, the polyurethane foam 13 is coated with a second adhesive 14, and a backing cloth 15 is adhered to the second adhesive 14. The vehicle sheet is obtained by adhering the material 11, the polyurethane foam 13, and the backing cloth 15.

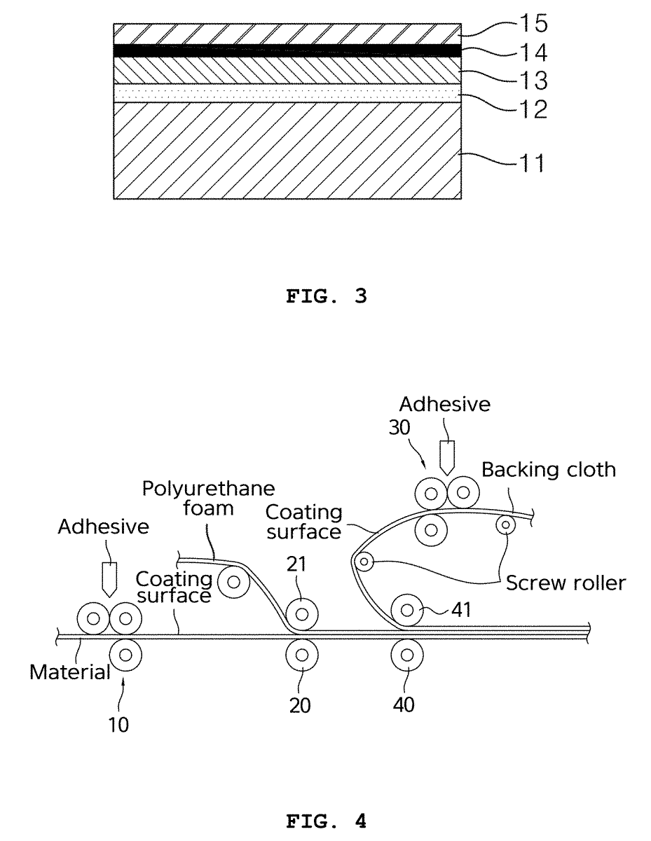

FIG. 4 is an illustrative view showing a device for manufacturing a vehicle sheet according to the present invention.

A first coating unit 10 coats the supplied material 11 with the first adhesive 12.

A first pressing roller 21 presses the polyurethane foam 13, which is supplied to the material 11 coated with the first adhesive 12.

A second coating unit 30 coats the backing cloth 15, which is supplied while being spread using a screw roller, with the second adhesive 14.

A second pressing roller 41 presses the backing cloth 15 coated with the second adhesive 14 on the pressed polyurethane foam 13, thus manufacturing the vehicle sheet.

When the rear surface of first material (woven fabric, artificial fabric: PU or TPU) is coated with the first adhesive 12 (moisture-curing polyurethane adhesive), the adhesive is applied in a coating amount of 10 to 30 g/m² regardless of the thickness and the density of the polyurethane foam 13. In the second simultaneous working of the backing cloth 15, the surface of the backing cloth 15 is coated with the second adhesive 14 in a coating amount of 5 to 20 g/m². The coating amount of both surfaces of the material using the adhesive is reduced by about 5 to 20 g/m² in a first/second material coating method, compared to a conventional working method in which the single surface of the polyurethane foam 13 is coated once. Accordingly, an effect of reducing material costs is secured, and even when the thickness and the density of the polyurethane foam 13 vary depending on the application area of interior materials for vehicles, working conditions are not changed. Further, simultaneous and continuous working is capable of being performed using the three substances, namely the material 11, the polyurethane foam 13, and the backing cloth 15 or non-woven fabric, which maximizes production efficiency.

Particularly, since the substance of the backing cloth 15 is woven fabrics (yarns 15 denier, 20 denier, 50 denier, 150 denier, mesh-type), in the technology of a method of coating the surface of the backing cloth 15 with the second adhesive 14 (moisture-curing polyurethane hot melt), the viscosity of the moisture-curing polyurethane resin must be 20,000 mPa·s and the temperature of the adhesive melting roller must be 100° C. in order to prevent the adhesive from flowing through the rear surface while passing through the second pressing roller 41 after coating. Further, coating must be performed while the backing cloth 15 is spread without folding on the screw roller before first coating. The backing cloth 15 must be evenly spread on the screw roller after second coating so that wrinkles are not formed and a peeling phenomenon is prevented during pressing by the second pressing roller 41.

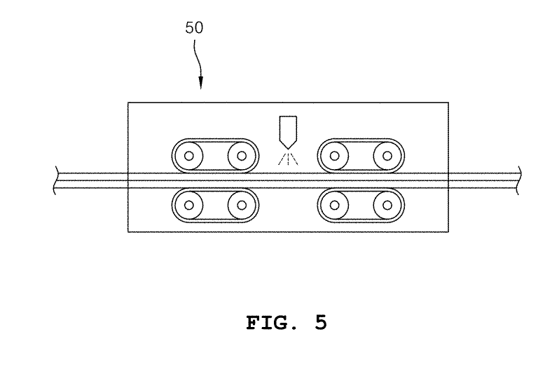

FIG. 5 is an illustrative view showing a cooling unit 50.

A cooling unit 50 cools the vehicle sheet after passing through the second pressing roller 41 to a cooling temperature of 0 to 10° C. and a cooling air pressure of 0.03 to 0.10 mPa using a cooling nozzle.

Since the melting temperature of the moisture-curing polyurethane hot melt resin, which is the first adhesive 12 and the second adhesive 14, is 70 to 120° C., rapid cooling is required after initial coating and adhering.

In the case of the cooling unit 50 for reducing an initial adhesion speed, the cooling unit 50 is provided after adhering of both surfaces, thus reducing a first curing speed.

The temperature of cooling using the cooling nozzle is 0 to 10° C., and the cooling air pressure is 0.03 to 0.10 mPa in order to prevent a peeling phenomenon between the material 11 and the polyurethane foam 13.

When the cooling air pressure is very high, the peeling phenomenon occurs between the material 11 and the polyurethane foam 13 due to the air pressure.

After the moisture-curing polyurethane hot melt adhesive (resin) is provided during a curing-speed reducing process, experimental results related to the peelability verification of the product are obtained.

Verification of working conditions, cooling temperature and cooling pressure conditions, curing time, and peeling strength

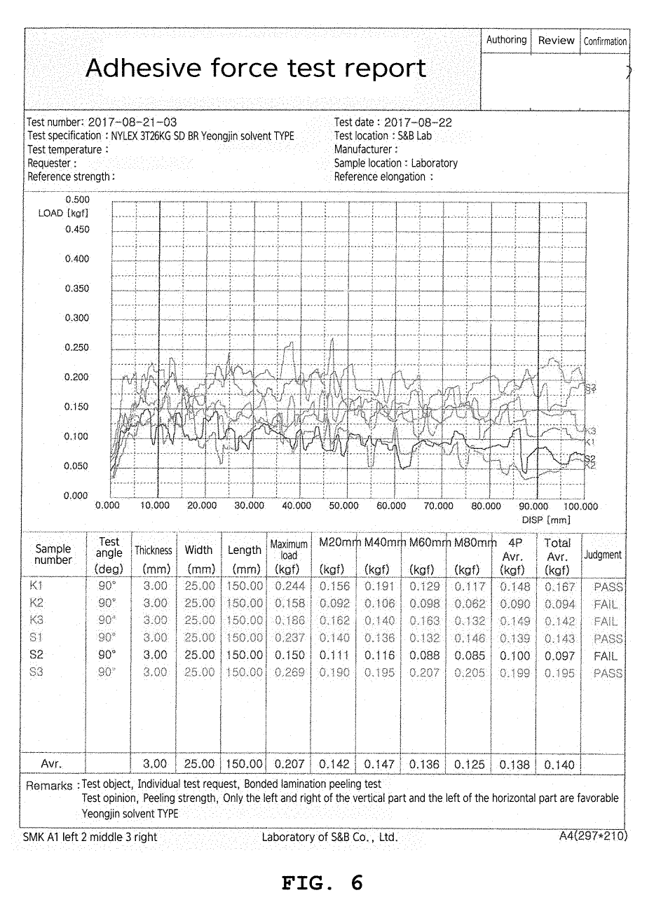

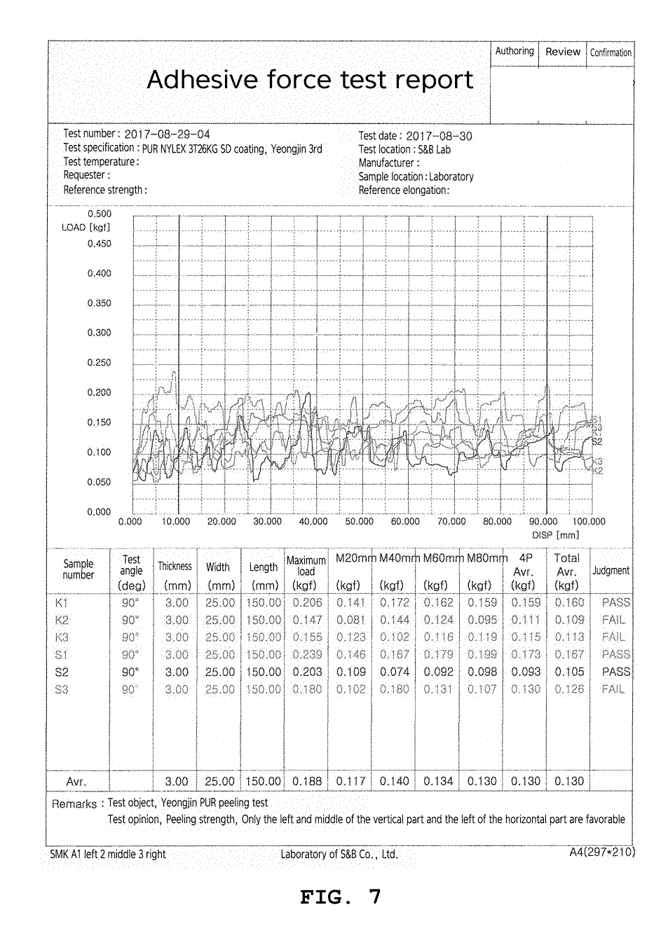

As shown in FIG. 6, a peeling test report at a curing time of 24 hours is attached. The peeling strength is 0.207 kgf at maximum load.

As shown in FIG. 7, a peeling test report at a curing time of 24 hours is attached. The peeling strength is 0.188 kgf at maximum load.

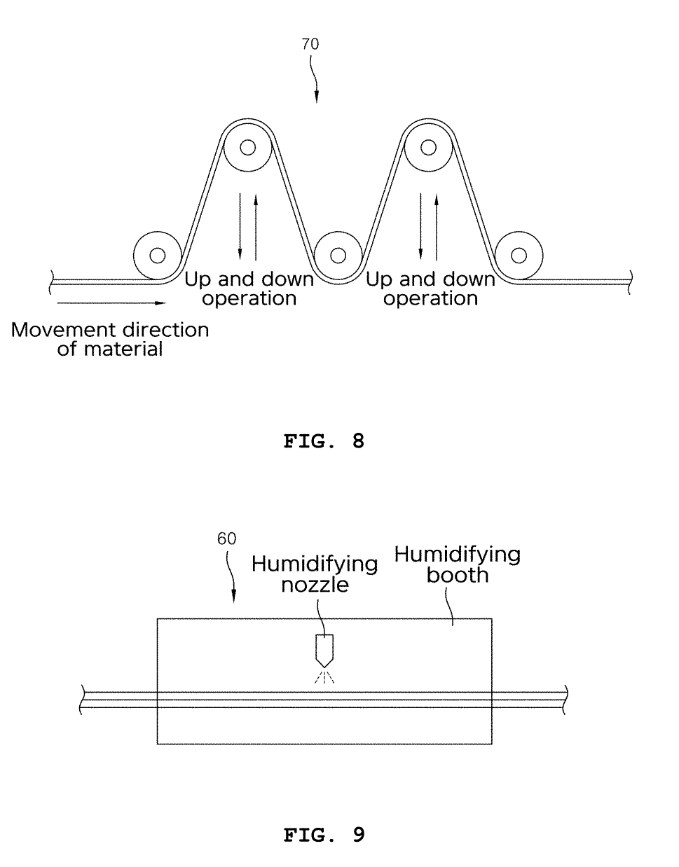

FIG. 8 is an illustrative view showing an accumulator.

An accumulator 70 is a storage device for enabling continuous working.

The accumulator 70 is lifted up when the finished product is wound in a roll unit in a finishing unit to thus store the laminated material, and is lowered when finishing rolling is again performed to thus enable continuous working, thereby improving productivity.

FIG. 9 is an illustrative view showing a humidifying unit 60.

The humidifying unit 60 cures the vehicle sheet after passing through the cooling unit 50 at a relative humidity of 70 to 95%, a humidifying-nozzle air pressure of 0.03 to 0.10 mPa, and an internal temperature of 30 to 40° C. using a humidifying nozzle.

Due to the characteristic of the moisture-curing hot melt adhesive, which is the first adhesive 12 and the second adhesive 14, the moisture-curing hot melt adhesive is reacted with moisture to be cured. Accordingly, the curing speed is reduced due to the provision of a second humidifying unit 60.

The relative humidity is 70 to 95%, and the humidifying-nozzle air pressure is 0.03 to 0.10 mPa in order to prevent a peeling phenomenon between the material 11 and the polyurethane foam 13.

When the cooling air pressure is high, the peeling phenomenon occurs between the material 11 and the polyurethane foam 13 due to the air pressure.

The internal temperature of the humidifying unit is room temperature of 30 to 40° C.

Provided are the results of the product curing speed and peeling strength verification after the same process under a first-curing-speed-reducing-working condition in the cooling unit 50 and after a continuous process in a second-curing-speed-reducing-working condition process in the humidifying unit 60.

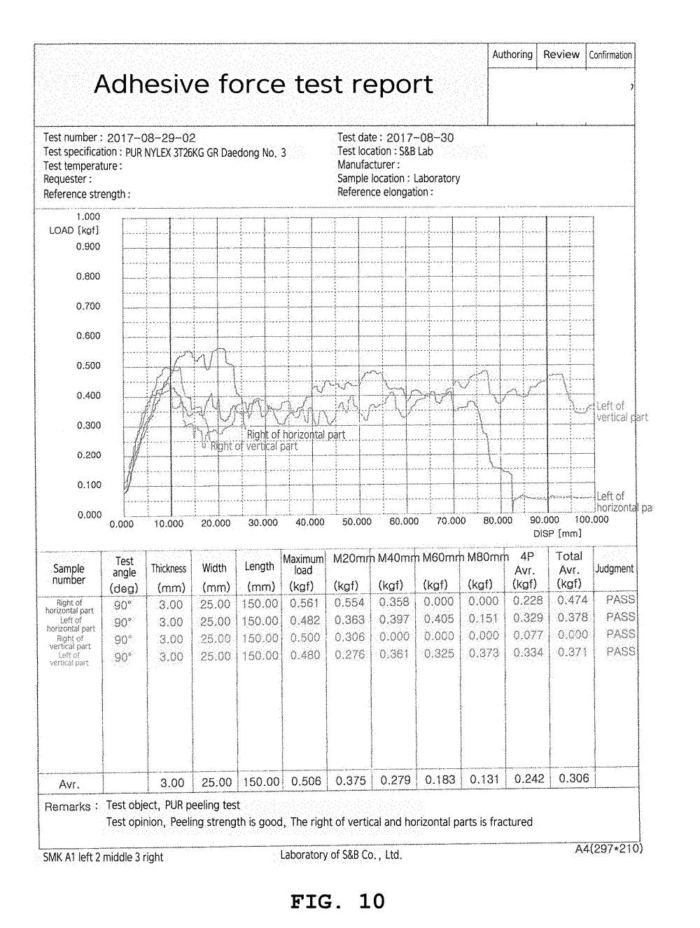

As shown in FIG. 10, a peeling test report at a curing time of 24 hours is attached. The peeling strength is 0.506 kgf at maximum load.

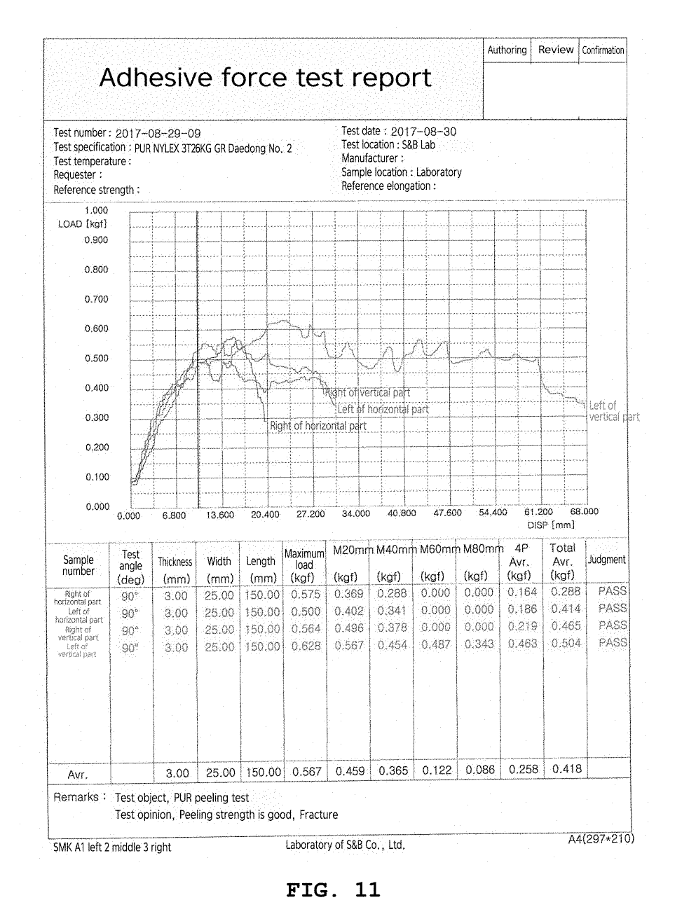

As shown in FIG. 11, a peeling test report at a curing time of 24 hours is attached. The peeling strength is 0.567 kgf at maximum load.

The curing time of 24 hours means complete curing. As described above, the problem of adhesive sticking to the cutting knife and the peeling phenomenon were not confirmed at the time of cutting the materials 11 after a first process and a second process.

The reason why the humidifying unit 60 is provided as described above is to ensure uniform quality irrespective of the season.

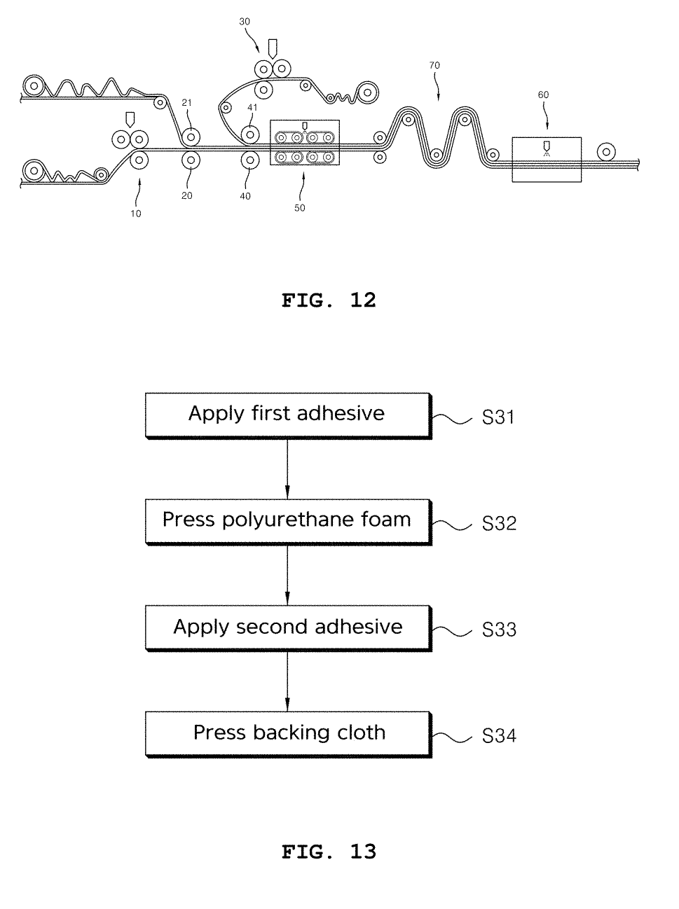

FIG. 12 is an illustrative view showing the overall constitution of a device for manufacturing a vehicle sheet according to the present invention.

A first coating unit 10 coats supplied material 11 with a first adhesive 12.

A first pressing roller 21 presses the polyurethane foam 13 which is supplied to the material 11 coated with the first adhesive 12.

A second coating unit 30 coats the backing cloth 15, which is supplied while being spread using a screw roller, with a second adhesive 14.

A second pressing roller 41 presses the backing cloth 15 coated with the second adhesive 14 on the pressed polyurethane foam 13, thus manufacturing the vehicle sheet.

The first adhesive 12 and the second adhesive 14 are a moisture-curing polyurethane adhesive, the coating amount of the first adhesive 12 is 10 to 30 g/m², the coating amount of the second adhesive 14 is 5 to 20g/m², the viscosity of the resin is 20000 mPa·s, and the temperature of the adhesive melting roller is 100° C.

A cooling unit 50 cools the vehicle sheet, after passing through the second pressing roller 41, to a cooling temperature of 0 to 10° C. and a cooling air pressure of 0.03 to 0.10 mPa using a cooling nozzle.

An accumulator 70 is a storage device for enabling continuous working.

A humidifying unit 60 cures the vehicle sheet after passing through the accumulator 70 and the cooling unit 50 at a relative humidity of 70 to 95%, a humidifying-nozzle air pressure of 0.03 to 0.10 mPa, and an internal temperature of 30 to 40° C. using a humidifying nozzle.

FIG. 13 is an operation flowchart showing the method of manufacturing the vehicle sheet.

The method of manufacturing the vehicle sheet will be described.

The device for manufacturing the vehicle sheet includes a program memory for storing a program, a data memory for storing data, and a processor for executing the program.

Reviewing the data stored in the program memory, the program memory includes coating supplied material 11 with a first adhesive 12 (S31), pressing a polyurethane foam 13 which is supplied to the material 11 coated with the first adhesive 12 (S32), coating a backing cloth 15, which is supplied while being spread using a screw roller, with a second adhesive 14 (S33), and pressing the backing cloth 15 coated with the second adhesive 14 on the pressed polyurethane foam 13, thus manufacturing the vehicle sheet (S34).

In the device for manufacturing the vehicle sheet, the program stored in the program memory is executed using the processor, and this operation will be described as follows.

The procedure executed in the device for manufacturing the vehicle sheet will be described in time series.

The device for manufacturing the vehicle sheet coats the supplied material 11 with the first adhesive 12.

The device for manufacturing the vehicle sheet presses the polyurethane foam 13 which is supplied to the material 11 coated with the first adhesive 12.

The device for manufacturing the vehicle sheet coats the backing cloth 15, which is supplied while being spread using a screw roller, with the second adhesive 14.

The device for manufacturing the vehicle sheet presses the backing cloth 15 coated with the second adhesive 14 on the pressed polyurethane foam 13, thus manufacturing the vehicle sheet.

The first adhesive 12 and the second adhesive 14 are a moisture-curing polyurethane adhesive, the coating amount of the first adhesive 12 is 10 to 30 g/m², the coating amount of the second adhesive 14 is 5 to 20 g/m², the viscosity of the resin is 20000 mPa·s, and the temperature of the adhesive melting roller is 100° C.

The device for manufacturing the vehicle sheet cools the manufactured vehicle sheet to a cooling temperature of 0 to 10° C. and a cooling air pressure of 0.03 to 0.10 mPa using a cooling nozzle.

The device for manufacturing the vehicle sheet cures the vehicle sheet after passing through the cooling step at a relative humidity of 70 to 95%, a humidifying-nozzle air pressure of 0.03 to 0.10 mPa, and an internal temperature of 30 to 40° C. using a humidifying nozzle.

While the present invention has been particularly shown and described with reference to preferred embodiments thereof, it will be understood by those of ordinary skill in the art that various changes and modifications may be made therein without departing from the spirit and scope of the present invention as defined in the following claims.

What is claimed is:

1. A device for manufacturing a vehicle sheet using a moisture-curing polyurethane hot melt, the device comprising:
a first coating unit coating a supplied material with a first adhesive;
a first pressing roller pressing a polyurethane foam which is supplied to the material coated with the first adhesive;
a second coating unit coating a backing cloth, which is supplied while being spread using a screw roller, with a second adhesive; and
a second pressing roller pressing the backing cloth coated with the second adhesive or a non-woven fabric on the pressed polyurethane foam, thus manufacturing the vehicle sheet.

2. The device of claim 1, wherein the first adhesive and the second adhesive are a moisture-curing polyurethane adhesive, a coating thickness of the first adhesive and the second adhesive is experimentally selected so that the polyurethane foam is prevented from contracting, a coating amount of the first adhesive is 10 to 30 g/m², a coating amount of the second adhesive is 5 to 20 g/m², a viscosity of a resin is 20000 mPa·s, and a temperature of an adhesive melting roller is 100° C.

3. The device of claim 1, further comprising:
a cooling unit cooling the vehicle sheet after passing through the second pressing roller to a cooling temperature of 0 to 10° C. and a cooling air pressure of 0.03 to 0.10 mPa using a cooling nozzle.

4. The device of claim 3, further comprising:
a humidifying unit curing the vehicle sheet after passing through the cooling unit at a relative humidity of 70 to 95%, a humidifying-nozzle air pressure of 0.03 to 0.10 mPa, and an internal temperature of 30 to 40° C. using a humidifying nozzle.

5. A method of manufacturing a vehicle sheet using a moisture-curing polyurethane hot melt, the method comprising:
coating a supplied material with a first adhesive;
first-pressing a polyurethane foam which is supplied to the material coated with the first adhesive;
coating a backing cloth, which is supplied while being spread using a screw roller, with a second adhesive; and
second-pressing the backing cloth coated with the second adhesive on the pressed polyurethane foam, thus manufacturing the vehicle sheet.

6. The method of claim 5, wherein the first adhesive and the second adhesive are a moisture-curing polyurethane adhesive, a coating amount of the first adhesive is 10 to 30 g/m², a coating amount of the second adhesive is 5 to 20 g/m², a viscosity of a resin is 20000 mPa·s, and a temperature of an adhesive melting roller is 100° C.

7. The method of claim 5, further comprising:
cooling the manufactured vehicle sheet to a cooling temperature of 0 to 10° C. and a cooling air pressure of 0.03 to 0.10 mPa using a cooling nozzle.

8. The method of claim 7, further comprising:
curing the vehicle sheet after passing through the cooling at a relative humidity of 70 to 95%, a humidifying-nozzle air pressure of 0.03 to 0.10 mPa, and an internal temperature of 30 to 40° C. using a humidifying nozzle.
